(19) United States
(12) Patent Application Publication
(10) Pub. No.: US 2016/0071042 A1
(43) Pub. Date: Mar. 10, 2016

(54) Quoting Tool and Design Module for Continuous Emission Monitoring Systems

(71) Applicant: Shanglong Wang, Marlton, NJ (US)

(72) Inventor: Shanglong Wang, Marlton, NJ (US)

(73) Assignee: JM-Stanley LLC, Marlton, NJ (US)

(21) Appl. No.: 14/943,921

(22) Filed: Nov. 17, 2015

Related U.S. Application Data
(60) Provisional application No. 62/080,892, filed on Nov. 17, 2014.
(60) Provisional application No. 62/090,361, filed on Dec. 11, 2014.

(51) Int. Cl. G06Q 10/06; G06Q 30/00

(52) U.S. Cl. CPC G06Q 10/06313; G06Q 30/018

(57) ABSTRACT

Disclosed is a quoting tool and a design module for continuous emission monitoring system (CEMS). In one embodiment, the quoting tool is accessible via a website, and provides an interactive user interface for receiving user input and a request for a quote. When the quote is calculated and approved, the user input is used to automatically generate design drawings via the design module, which utilizes CAD API programming. Each of the quoting tool and the design module receives optimization input from a knowledge base to minimize errors and increase quality. The finalized design drawings are used to create bill of materials for assembling CEMS products. Because the instant invention streamlines the process of calculating quotes and drafting design drawings, the present system is configured to reduce project lead times and labor associated therewith.

### CROSS-REFERENCE TO RELATED APPLICATIONS

This application claims the benefit of U.S. Provisional Application No. 62/080,892, filed Nov. 17, 2014, and U.S. Provisional Patent Application No. 62/090,361, filed Dec. 11, 2014, which are hereby incorporated by reference in their entirety.

### FIELD OF THE INVENTION

The present invention generally relates to continuous emission monitoring systems (CEMS). More particularly, the present invention is directed to a system and method for quoting, designing, and delivering CEMS products.

### BACKGROUND OF THE INVENTION

There has been an increased demand and recognition for monitoring and minimizing the discharge of waste products into the atmosphere. In this regard, CEMS are used as a tool to monitor flue gas for oxygen, carbon monoxide, carbon dioxide, and other types of gases to provide information for combustion control in industrial settings. The CEMS industry relies heavily on engineering experiences, and is labor intensive.

A typical CEMS project is composed of hundreds of components provided by different manufacturers and vendors. The current method of fulfilling a request for CEMS products requires a CEMS vendor must repeatedly communicate with a customer to understand the customer's requirements. Each component for the product must be selected by experienced engineers or other professionals to meet required specifications. In some cases, customers are given limited options and are not provided with alternate options to reduce costs. Thus, it is time consuming and difficult to receive optimal quotes for CEMS products.

Additionally, it generally takes several weeks for the CEMS customer to receive design drawings due to the complexity of CEMS design. First, a CEMS engineer must spend extensive amount of time to understand the project scope defined in a project turnover package prepared by an inquiry-to-order (ITO) team. Thereafter, the engineer must incorporate dozens of wiring and plumbing connections as well as hundreds of electrical and mechanical parts into the design drawings for the project. Thus, the design phase is often a tedious and a prolonged process.

After preparing a design drawing package, the engineer is required to proof the drawings several times to ensure that all of the mistakes are eliminated before the design drawings come into production. It is an exceedingly difficult process for traditional CEMS vendors to eliminate rework in design and production, however, because CEMS designs are very complex and detailed. Additionally, due to the trial-and-error nature of CEMS designs, it is difficult for CEMS vendors to deliver tested CEMS products within a short period of time. For traditional CEMS vendors, therefore, a large amount of time and money are spent on design revisions and hardware reworks. In this regard, the invention described herein addresses these problems.

### SUMMARY OF THE INVENTION

The following discloses a simplified summary of the specification in order to provide a basic understanding of some aspects of the specification. This summary is not an extensive overview of the specification. It is intended to neither identify key or critical elements of the specification nor delineate the scope of the specification. Its sole purpose is to disclose some concepts of the specification in a simplified form as to prelude to the more detailed description that is disclosed later.

In one embodiment, the present invention comprises a parametric quoting tool that categorizes complex CEMS products into several modules. Non-limiting examples of modules include HVAC, circuit breaker, calibration gas, shelter, IO box, sample line, sample pump, sample conditioning device, sample probe, PLC control panel, and analyzer. Additionally, if CEMS type is fully extractive, then sample conditioning devices are needed. If CEMS type is dilution extractive, then dilution air clean-up module is needed. For each module, the CEMS products are further broken down to different part options. By using ASP.NET programming and SQL database technology, the quoting tool guides customers interactively and expeditiously to make compatible part selections from the part database, and to build a CEMS quote with a complete parts list.

In another embodiment, the present invention comprises a design system. The design system uses parametric methods to divide complex CEMS products into modules. Each module is further broken down to two categories: 1) layout design; and 2) wiring and plumbing connections. By using CAD API, SQL database technology and .Net programming, the design system retrieves 3D CAD models, i.e., used for layout design of CEMS assemblies, and standard design drawings automatically from knowledge databases to automatically generate a complete design drawing package to meet a customer's requirements. In this regard, the drafting process for design drawing is significantly expedited.

The present system can receive inputs directly from customers, i.e., end users, via the present parametric quoting tool. The back end of the system translates the customers' inputs into selections of proper CEMS components interactively. After a customer finalizes his or her inputs, a CEMS quote is automatically calculated. For example, the selection of a HVAC is based on a number of factors, such as surrounding temperature, wind speed, humidity level, and CEMS shelter dimensions, among others.

In another example, the system automatically calculates the list of calibration gas bottles to meet all the regulatory requirements based on the user input of the emission types and corresponding emission concentrations. Additionally, the system automatically generates design drawings based on the customer input. Because the system is optimized, the design drawings generated from the present system comprise a smaller margin of error than design drawings generated from existing systems. In this regard, the present system ensures a smooth implementation of CEMS products to meet customers' requirements.

It is therefore an objective of the present invention to provide a parametric quoting tool and a design module that reduces project lead time while providing uniquely defined CEMS quotes and delivering finalized design drawings in an expedited manner.

It is another objective of the present invention to provide a parametric quoting tool and a design module that significantly reduces engineering work and project management related costs.

It is still another objective of the present invention to provide a system that automates most drawing drafting work while reducing reworks in design and manufacturing.

It is still another objective of the present invention to provide a parametric quoting tool and a design module that can minimize inventory levels.

It is still another objective of the present invention to provide a parametric quoting tool and a design module that can reduce labor hours in CEMS quoting, design, and manufacturing.

It is another objective of the present invention to provide a parametric quoting tool and a design module that integrates inquiry-to-order (ITO) and order-to-remittance (OTR) procedures.

A final objective of the present invention to provide a system that can be readily updated and continuously improved to eliminate any errors.

In the light of the foregoing, these and other objective are accomplished in accordance of the principles of the present invention, wherein the novelty of the present invention will become apparent from the following detailed description and appended claims.

### BRIEF DESCRIPTION OF THE DRAWINGS

The above and other objects and advantages of the present invention will be apparent upon consideration of the following detailed description, taken in conjunction with the accompanying exemplary drawings, in which like reference characters refer to like parts throughout, and in which:

FIG. 1A depicts a simplified work flowchart of the present system.

FIG. 1B shows streamlined ITO and OTR procedures of the present invention.

FIGS. 2A and 2B show a prior art ITO procedure and a prior art OTR procedure, respectively.

FIG. 3 depicts an exemplary block diagram of the present invention.

FIG. 4 shows a simplified work flowchart of the present system.

FIG. 5 shows an exemplary structure of the present expert system.

FIG. 6 depicts an exemplary work flowchart of the present quoting tool.

### DETAILED DESCRIPTION OF THE INVENTION

The present invention is directed towards a CEMS quoting tool and design automation module. For purposes of clarity, and not by way of limitation, illustrative views of the present system and method are described with references made to the above-identified figures. Various modifications obvious to one skilled in the art are deemed to be within the spirit and scope of the present invention.

As used in this application, the terms “component,” “module,” “system,” “interface,” or the like are generally intended to refer to a computer-related entity, either hardware or a combination of hardware and software. For example, a component can be, but is not limited to being, a process running on a processor, an object, and/or a computer. By way of illustration, both an application running on a controller and the controller can be a component. One or more components can reside within a process and/or thread of execution and a component can be localized on one computer and/or distributed between two or more computers. As another example, an interface can include I/O components as well as associated processor, application, and/or API components.

Furthermore, the claimed subject matter can be implemented as a method, apparatus, or article of manufacture using standard programming and/or engineering techniques to produce software, firmware, hardware, or any combination thereof to control a computer to implement the disclosed subject matter. The term “article of manufacture” as used herein is intended to encompass a computer program accessible from any computer-readable device, or media.

Moreover, the word “exemplary” is used herein to mean serving as an example, instance, or illustration. Any aspect or design described herein as “exemplary” is not necessarily to be construed as preferred or advantageous over other aspects or designs. Rather, use of the word exemplary is intended to disclose concepts in a concrete fashion. As used in this application, the term “or” is intended to mean an inclusive “or” rather than an exclusive “or.” Additionally, the articles “a” and “an” as used in this application and the appended claims should generally be construed to mean “one or more” or “at least one” unless specified otherwise or clear from context to be directed to a singular form. Furthermore, terms “customer” and “user” are used interchangeably, unless the context clearly indicates otherwise. It is to be appreciated that determinations or inferences referenced throughout the subject specification can be practiced through the use of artificial intelligence techniques.

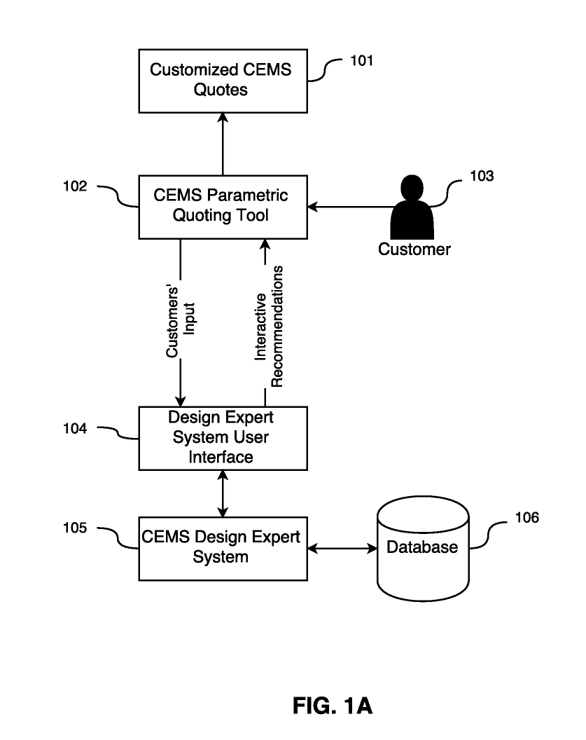

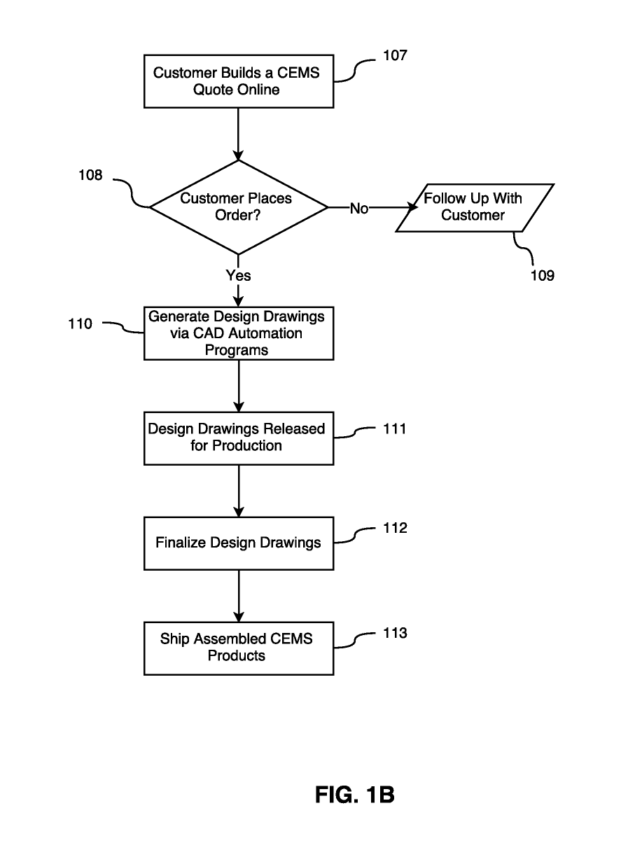

Referring now to FIGS. 1A and 1B, there is shown a work flowchart of the present system and the present streamlined ITO and OTR procedures, respectively. The present system allows a customer 103 or another end user to select CEMS components that best fits his or her requirements and needs via a CEMS parametric quoting tool 102. The quoting tool 102 is accessible via a website, web application, or the like. Thus, various types of computer systems having a network connection, e.g., Internet, LAN, may be used to access the CEMS parametric quoting tool 102. It is contemplated that the website or the web application allows each customer to create an account prior to building his or her quote, which is then saved to the account. All of the account information is saved in a database 106 or a server of the present system. Further, the website or the web application comprises a graphic user interface (GUI) that provides an online application in a form of lists of available CEMS products in modules. For some itemized modules, the GUI comprises drop down menus from which the customer can select input values. For other itemized modules, the GUI comprises a text entry box for entering input values. In some embodiments, the quoting tool 102 can also be used offline or through intranet by the CEMS provider.

Alternatively, the system may utilize a design knowledge database to automatically build a quote using preapproved parameters. A customer's requirements may depend on the needs of specific emission source, types of fossil fuel, types of gas emission to be measured, gas concentration ranges, and environmental monitoring standards among regions, among other factors. When all of the CEMS components are recommended by system or explicitly selected by a user in the online application, the quoting tool 102 links the part selections with virtual parts stored in a SQL database to form a complete CEMS parts list. The CEMS parametric quoting tool 102 retrieves prices of CEMS parts. For each CEMS module, labor charges are also retrieved by parametric CEMS quoting tool 102. The costs of parts and related module labor charges are re-organized to generate customized CEMS quotes 101, which are displayed, preferably in a detailed itemized format, on the website or the web application.

The customer's input is transmitted to a design expert system user interface 104, which communicates with a CEMS design expert system 105. It is contemplated that the CEMS design expert system 105 comprises a server or another computer system. The CEMS design expert system 105 is in communication with at least one database 106 so as to retrieve relevant information therefrom. Based on the information retrieved from the database 106, the CEMS design expert system 105 relays data back to the design expert system user interface 104, which provides interactive recommendations to the customer 103 via the CEMS parametric quoting tool 102.

Thus, the present system allows a customer to build his or her own CEMS quote 107 using the CEMS parametric quoting tool 102 and place an order 108. If the customer does not place an order after building a quote, the system can follow up with the customer 109 to determine whether the customer needs assistance. The follow up may be accomplished by sending an automated email or conducting a courtesy call. If the customer places an order 108, the system automatically generates design drawings via CAD automation programs 110. The design drawings are then released for production 111 and finalized 112. Once the drawings are finalized and released for production, CEMS products are assembled and shipped to the customer 113.

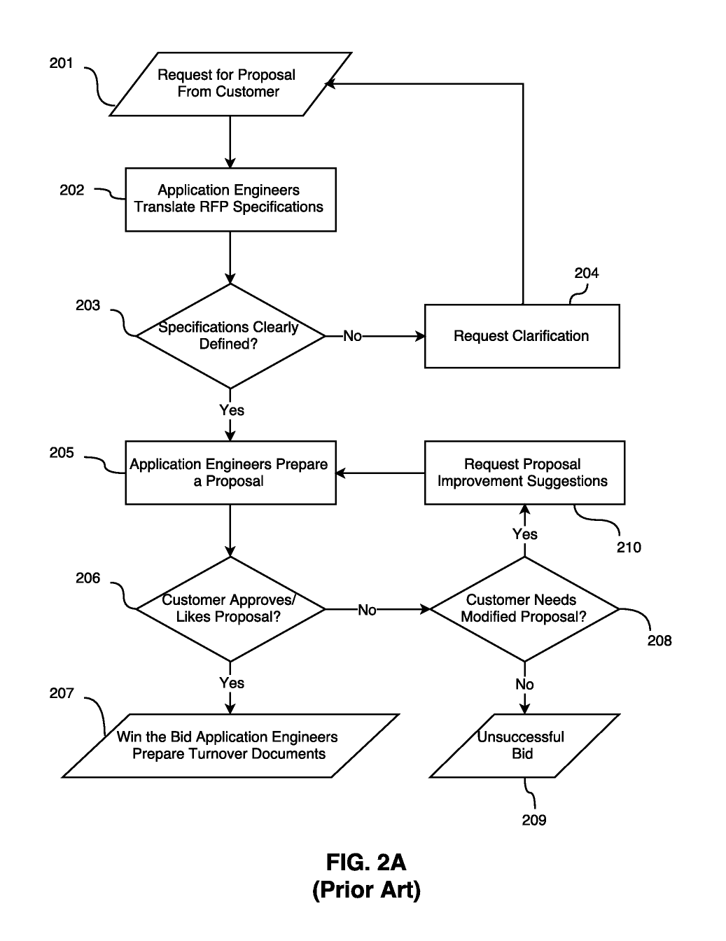

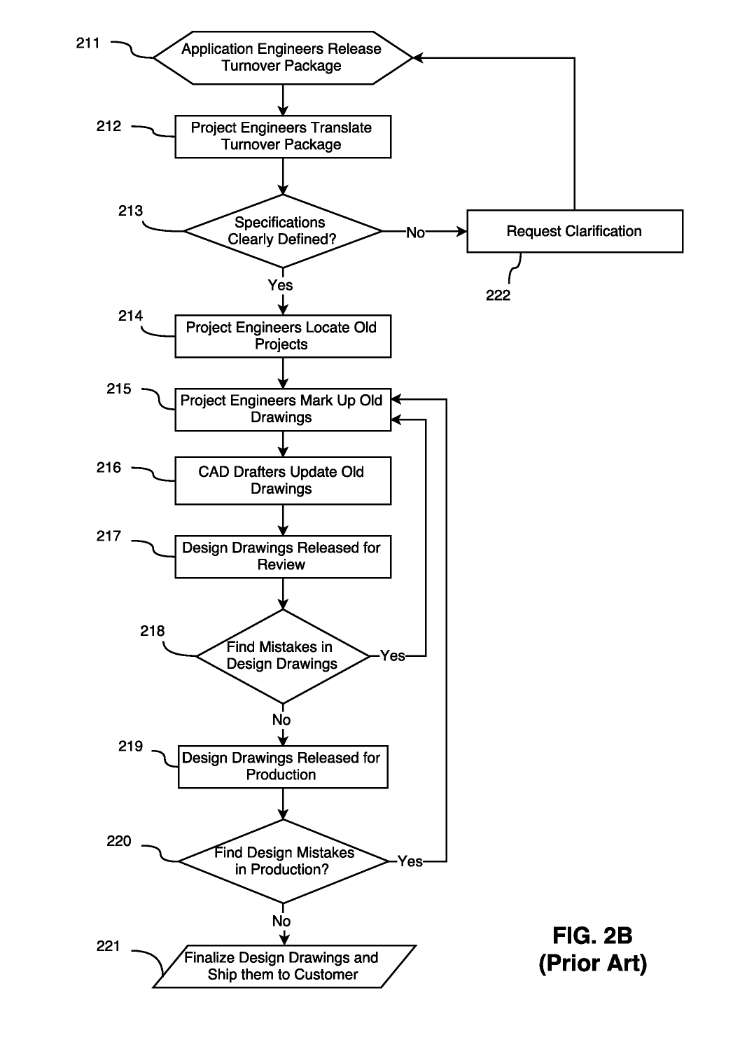

Referring now to FIGS. 2A and 2B, there are shown diagrams of typical prior art ITO and OTR procedures, respectively. The prior art ITO procedure requires application engineers to translate a request for proposal (RFP) specification 202 once they receive the RFP from a customer 201. If the RFP specifications are not clear 203, the application engineers must request for clarification 204 from the customer until the engineers can understand the specifications to prepare a proposal 205. Once drafted, the proposal is sent to the customer for approval 206.

If the customer does not approve of the proposal, the engineers must determine whether the customer needs a modified proposal 208. If the customer needs or requests a modified proposal, the engineers can request proposal for improvement or suggestions from the customer 210 before preparing a new proposal 205. This process is repeated until the customer approves the proposal or does not wish to receive further proposals, which then renders the bid unsuccessful 209. If the customer approves the proposal, then the application engineers can prepare turnover documents 207.

The OTR procedure includes the steps of the application engineers releasing a turnover package 211. Upon receiving the turnover package, project engineers must then translate the package 212 to determine whether the specifications are clearly defined 213. If the specifications are not clearly defined, the project engineers can request for clarification 222 before proceeding. If the specifications are clearly defined, then the project engineers can locate old projects 214 that are similar to the RFP in question so as to eliminate the need to prepare design drawings from scratch. The old drawings are then marked up 215 and updated 216 manually.

Once CAD drafters update the old drawings 216, the design drawings are released for review 217. If there are any errors in the design drawings 218 or better designs are available, the project engineers must mark up the drawings again 215 until all errors are resolved. The design drawings are then released for production 219. If there are further errors in design 220, the design drawings are returned to the project engineers for further mark up 215. If there are no more design errors, the design drawings are finalized 221. Accordingly, the prior art ITO and OTR procedures are very inefficient, time consuming, and labor intensive.

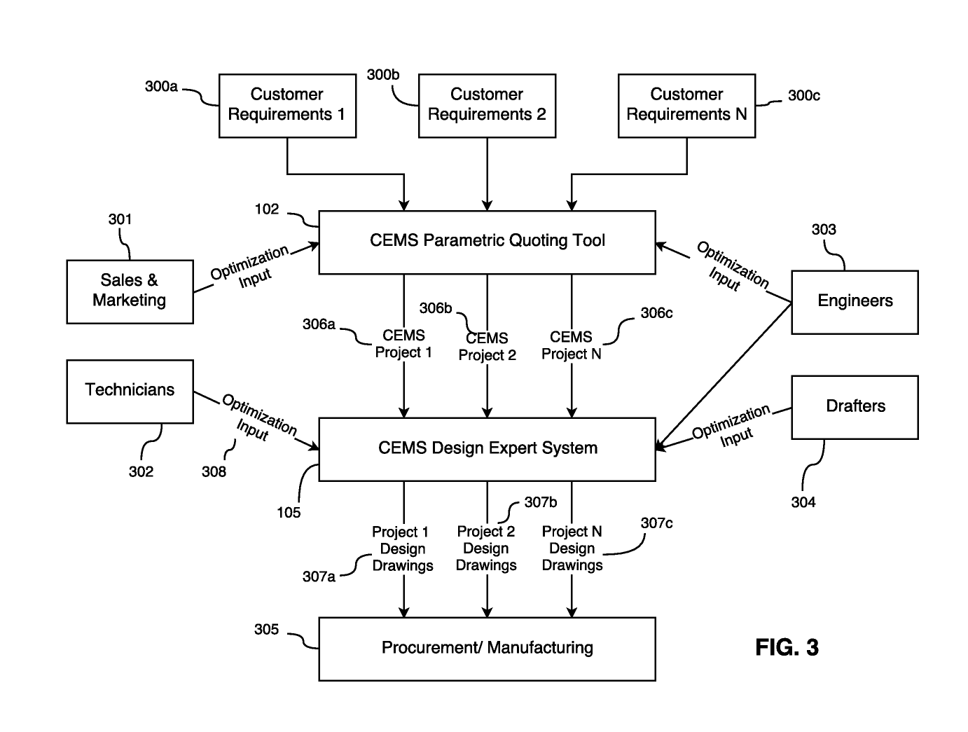

Referring now to FIG. 3, there is shown an exemplary block diagram of the present invention. The system receives one or more customer requirements 300a, 300b, 300c from customers. The requirements 300a, 300b, 300c are input into the CEMS parametric quoting tool. ASP.NET programming is used so as to allow ASP.NET webpages to receive the requirements 300a, 300b, 300c and retrieve part prices and labor charge from SQL databases. The CEMS parametric quoting tool 102 outputs a CEMS project proposal 306a, 306b, 306c for each of the customer requirements 300a, 300b, 300c. It is contemplated that each of the CEMS project 306a, 306b, 306c comprises calculated quotes and selected CEMS components for assembling CEMS products.

The project proposals 306a, 306b, 306c are then relayed to the CEMS design expert system 105, which automatically outputs custom design drawings 307a, 307b, 307c for each CEMS projects 306a, 306b, 306c. Each of the design drawings 307a, 307b, 307c comprises design variables to represent various configurations and functions of the wiring and plumbing. Once the design drawings 307a, 307b, 307c are finalized, they are sent to procurement and/or manufacturing 305.

In a preferred embodiment, the system is designed to be continuously improvable. Both the parametric quoting tool 102 and design expert system 105 can be upgraded upon receiving optimization inputs 308 from the engineers 303 and sales and marketing entities 301.

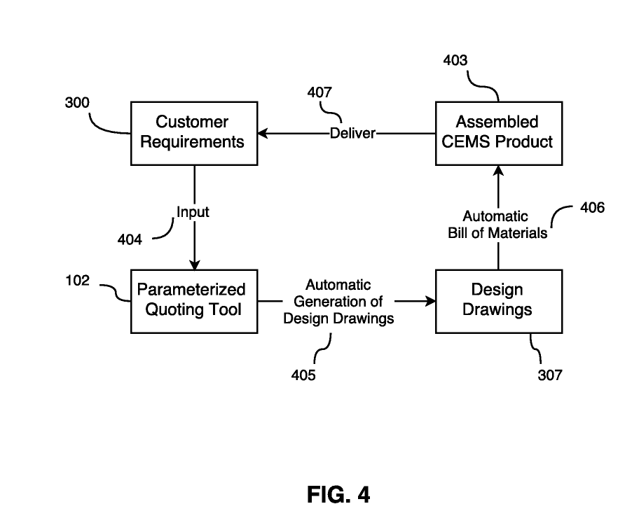

Referring now to FIG. 4, there is shown a simplified work flowchart of the present system. To begin, the system requires input from customers 300, which specifies various requirements and specification from the customers. The information is input 404 into the parameterized quoting tool 102, which then pushes through the input information to the present design system that automatically generates design drawings 405. If a customer is unable to complete building a quote, the customer can save the incomplete quote to his or her account and return to it at a later time to complete the quote. Once the design drawings 307 are finalized, a bill of materials (BoM) 406 is automatically transmitted to procurement and/or manufacturing to produce a CEMS product 403. Upon production, the assembled CEMS product 403 is delivered 407 to the customer.

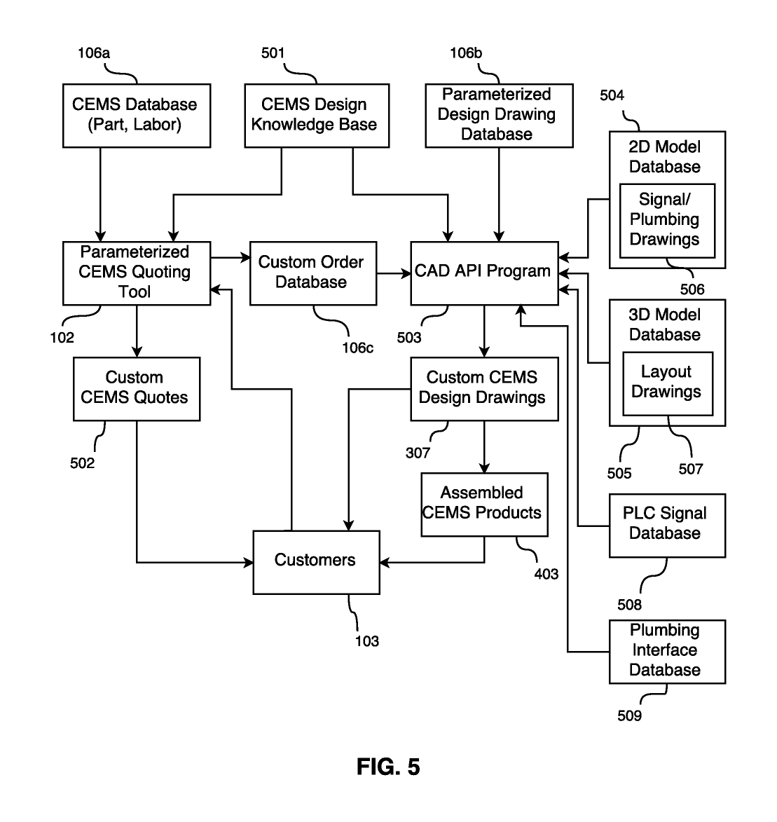

Referring now to FIG. 5, there is shown an exemplary structure of the present expert system. Customers 103 can access the present parameterized CEMS quoting tool 102 to build a quote. The CEMS quoting tool 102 is in communication with a CEMS database 106a that stores information relating to parts and labor costs and inventory. In some embodiments, the CEMS database 106a may be in further communication with third party servers to update parts and labor costs and inventory information. In this way, the CEMS quoting tool 102 can accurately calculate quotes and output custom CEMS quotes 502 with the most up-to-date information.

The quoting tool 102 also transmits input information to a custom order database 106c so that the custom orders are logged for recordkeeping and saved for future reference. In this regard, the custom orders are associated with respective user account information for facilitating retrieval of information. The input information is then transmitted to a CAD API program 503, which reads customer orders as inputs.

Based on input information, the CAD API program 503 retrieves functionally parameterized drawings, which include all types of pre-engineered CEMS products, and mainly relates to drawings involving PLC control signal and AC-DC power supply. In one embodiment, all PLC signal in a standardized CEMS project is listed, indexed, and stored in a database, e.g., a PLC signal database 508. Thereafter, standard drawings relating to the standardized CEMS project are categorized according to their function. The PLC signals that appear in the standard drawings are parameterized according to the indexing. The parameterized design drawings are stored in the parameterized design drawing database 106b.

In operation, the CAD API program 503 automatically identifies devices or modules used in a CEMS project and determines the type of PLC signals the devices or modules have. Once the type of PLC signals are identified, the program 503 can also identify the correlating index identifier. The CAD API program 503 then generates a PLC signal table for each input and output card, wherein the signal table comprises all locations assigned for digital input (DI), digital output (DO), analog input (AI), or analog output (AO) signals for various devices associated therewith. It is contemplated that DI, DO, AI, or AO signals for all parameterized drawings are indexed to match the PLC signal table.

Because the indexing process is continuous, there is no need to manually modify parameterized drawings to match the PLC signal table. The CAD API program 503 searches for all parameterized labels for each drawing, and then updates the labels into a predetermined format. In some embodiments, the parameterized labels for each drawing may be identical or similar to the labels for input and output card. In this regard, the program 503 matches the signals of a PLC input and output card with the signals of the parameterized drawings.

For example, a database may comprise a first drawing containing all PLC signal for a first device. When a customer includes the first device in his or her request for proposal, the CAD API program 503 can automatically extract the first drawing from the database. Accordingly, the CAD API program 503 automatically links customer orders directly with one or more parameterized drawings and related 3D CAD models based on PLC signals.

Similarly, the present invention comprises a plumbing interface database 509 in communication with the CAD API program 503, wherein the plumbing interface database 509 comprises indexed plumbing interfaces in the parameterized design drawings.

The CAD API program 503 is in communication with a 2D model database 504 and a 3D model database 505. The 2D model database 504 includes signal/plumbing drawings 506 and the 3D model database 505 includes layout drawings 507. In this way, the CAD API program 503 is configured to create 2D and 3D CAD models for all hardware that can displayed in layout design drawings, wherein layout designs are needed for most sub-assemblies such as analyzer racks, sample conditioning panels, instrument air clean-up panels, and terminal block assemblies. In some embodiments, the CAD API program 503 is further configured to create sub-assembly and CEMS shelter layout design.

The CAD API program 503 updates the wiring and plumbing connection information in the design drawings automatically. In this way, the CAD API program 503 facilitates in generating custom CEMS design drawings 307. The CEMS design drawings 307 are very detailed and include wiring and plumbing representations for major electrical and mechanical equipment. Alternatively, separate design drawings may be created for wiring and plumbing, and then combined together to form a complete design drawing package. Once completed, the design drawings 307 are sent to the customers 103. The design drawings 307 are also used to assemble CEMS products 403, which is delivered to the customers 103.

In the illustrated embodiment, the CEMS quotes 502 and design drawings 307 can be optimized via a CEMS design knowledge base 501, a server, which communicates with the parameterized CEMS quoting tool 102 and the CAD API program 503 via a network connection. In this way, the optimization input and the optimization process is automated and does not require manual input from engineers, technicians, or other professionals. Additionally, the CEMS design knowledge base 501 is configured to detect any errors within the design drawings and to determine whether or not a better design is available.

Any errors or edits to the design drawings are logged and/or recorded in the knowledge base 501 by updating parameterized drawings, 3D CAD models, and the CAD API program 503, e.g., machine learning algorithm, so that logged and/or recorded errors are not repeated in future design drawings, thereby improving the quality of CEMS design and production. Preferably, the CEMS design knowledge base 501 is continuously updated as new technologies and products become available and requests for proposals are submitted. In this regard, the CEMS quotes 502 and design drawings 307 are improved as the CEMS design knowledge base 501 becomes updated.

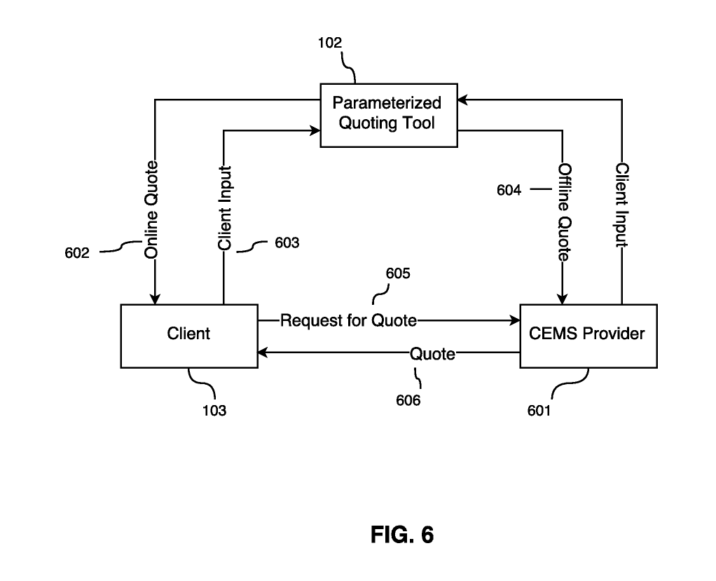

Referring now to FIG. 6, there is shown an exemplary work flowchart of the present quoting tool. The client or customer 103 requests a quote 605 to the CEMS provider 601. The CEMS provider can then enter client input 603 to the parameterized quoting tool 102. Alternatively, the customer 103 can directly provide client input 603 to the parameterized quoting tool 102. The parameterized quoting tool 102 can then provide an online quote 602 to the customer 103 or provide offline quote 604 to the CEMS provider 601. If the CEMS provider receives the offline quote 604, the CEMS provider can provide the quote 606 to the customer 103. The quotes may list all parts to be used for a CEMS project based on the client input 603 and 605. Current CEMS integrators are configured to supply a CEMS quote with a BoM. The BoM in the quote matches the BoM that is shown in the drawings.

It is therefore submitted that the instant invention has been shown and described in what is considered to be the most practical and preferred embodiments. It is recognized, however, that departures may be made within the scope of the invention and that obvious modifications will occur to a person skilled in the art. With respect to the above description then, it is to be realized that the optimum dimensional relationships for the parts of the invention, to include variations in size, materials, shape, form, function and manner of operation, assembly and use, are deemed readily apparent and obvious to one skilled in the art, and all equivalent relationships to those illustrated in the drawings and described in the specification are intended to be encompassed by the present invention.

Therefore, the foregoing is considered as illustrative only of the principles of the invention. Further, since numerous modifications and changes will readily occur to those skilled in the art, it is not desired to limit the invention to the exact construction and operation shown and described, and accordingly, all suitable modifications and equivalents may be resorted to, falling within the scope of the invention.

1. A system for processing a request for an assembled CEMS product, comprising:
a CEMS parametric quoting tool in communication with a network, said CEMS parametric quoting tool configured to provide an application that presents a list of CEMS products divided into modules, wherein said application receives customer input via a computer that has access to said CEMS parametric quoting tool to translate said customer input into selections of proper CEMS components interactively, further wherein said CEMS parametric quoting tool calculates a customized quote responsive to said customer input and presents said customized quote to a customer;
a CEMS design expert system in communication with said network and said CEMS parametric quoting tool, said CEMS design expert system comprising a CAD API program that is configured to receive said customer input from said CEMS parametric quoting tool and apply customer requirements within said customer input to produce design drawings for procurement and manufacturing;
a CEMS knowledge base in communication with said CEMS parametric quoting tool and said CEMS design expert system, said CEMS knowledge base configured to provide optimization input to each of said CEMS parametric quoting tool and said CEMS design expert system; and
at least one database in communication with said CEMS parametric quoting tool, said CEMS design expert system, said CEMS knowledge base, and said CAD API program.

2. The system of claim 1, wherein said at least one database comprises a CEMS database that stores information relating to parts and labor costs and inventory, further wherein said CEMS database is in communication with said CEMS parametric quoting tool to allow said CEMS parametric quoting tool to calculate said customized quote.

3. The system of claim 1, wherein said at least one database comprises a parameterized design drawing database for storing parameterized design drawings, further wherein said parameterized design drawing database is in communication with said CAD API program.

4. The system of claim 3, wherein said at least one database further comprises a PLC signal database;
said PLC signal database comprising indexed PLC signals in said parameterized design drawings;
said CAD API program further configured to identify said modules in said customer input and determine types of PLC signals of said modules and match said PLC signals of said modules with said indexed PLC signals;
if said CAD API program determines that said PLC signals of said modules and said indexed PLC signals match, said CAD API program automatically extracting one or more of said parameterized design drawings to produce said design drawings.

5. The system of claim 3, wherein said at least one database further comprises a plumbing interface database;
said plumbing interface database comprising indexed plumbing interfaces in said parameterized design drawings;
said CAD API program further configured to identify said modules in said customer input and determine types of plumbing interfaces of said modules and match said plumbing interfaces of said modules with said indexed plumbing interfaces;
if said CAD API program determines that said plumbing interfaces of said modules and said indexed plumbing interfaces match, said CAD API program automatically extracting one or more of said parameterized design drawings to produce said design drawings.

6. The system of claim 1, wherein said at least one database comprises a 2D model database for storing signal and plumbing drawings, and a 3D model database for storing layout drawings, further wherein each of said 2D model database and said 3D model database is in communication with said CAD API program, thereby enabling said CAD API program to include wiring and plumbing representations for major electrical and mechanical equipment in said design drawings.

7. The system of claim 1, wherein said CEMS knowledge base is further configured to continuously log said customer input and record edits to design drawings for providing quality assurance.

8. A computer-implemented method for furnishing quote for a CEMS product, the method comprising the steps of:
providing an application on a CEMS parametric quoting tool, wherein said application comprises a list of CEMS products divided into several modules;
receiving customer input in functional requirements and specification via a computer that has access to said CEMS parametric quoting tool, wherein said CEMS parametric quoting tool translates said customer input into selections of proper CEMS components interactively, further wherein said CEMS parametric quoting tool is configured to calculate a customized quote responsive to said customer input;
presenting said customized quote via said CEMS parametric quoting tool;
transmitting said customer input to a CEMS design expert system, said CEMS design expert system comprising a CAD API program that is configured to apply customer requirements within said customer input to produce design drawings; and
generating design drawings for procurement and manufacturing.

9. The computer-implemented method of claim 8, further comprising the steps of optimizing said customized quote by receiving optimization input from a CEMS knowledge base.

10. The computer-implemented method of claim 8, further comprising the steps of optimizing said design drawings by receiving optimization input from a CEMS knowledge base.

11. The computer-implemented method of claim 8, further comprising the steps of:
identifying error in said design drawings;
amending said design drawings, whereby amending said design drawings triggers a CEMS knowledge base to log said error.

12. A computer-implemented method for drafting design drawings for a CEMS product, the method comprising the steps of:
providing an application on a CEMS parametric quoting tool, wherein said application comprises a list of CEMS products divided into several modules;
receiving customer input in functional requirements and specification via a computer that has access to said CEMS parametric quoting tool, and wherein said CEMS parametric quoting tool translates said customer input into selections of proper CEMS components interactively, further wherein said CEMS parametric quoting tool is configured to calculate a customized quote responsive to said customer input;
presenting said customized quote via said CEMS parametric quoting tool;
transmitting said customer input to a CEMS design expert system, said CEMS design expert system comprising a CAD API program that is configured to identify said modules in said customer input and determine types of signals of said modules and match said signals of said modules with indexed signals in parameterized design drawings;
upon determining that said signals of said modules and said indexed signals match, extracting one or more of said parameterized design drawings for use as a template;
applying customer requirements within said customer input to produce design drawings; and
generating design drawings for procurement and manufacturing.

13. The computer-implemented method of claim 12, wherein said signals comprise PLC signals.

14. The computer-implemented method of claim 12, further comprising the steps of optimizing said customized quote by receiving optimization input from a CEMS knowledge base.

15. The computer-implemented method of claim 12, further comprising the steps of optimizing said design drawings by receiving optimization input from a CEMS knowledge base.

16. The computer-implemented method of claim 12, further comprising the steps of:
identifying error in said design drawings;
amending said design drawings, whereby amending said design drawings triggers a CEMS knowledge base to log said error.

17. The computer-implemented method of claim 12, further comprising the steps of:
identifying error in said design drawings;
amending said parameterized design drawings, whereby amending said parameterized design drawings triggers a CEMS knowledge base to log said error.

18. A system for processing a request for an assembled CEMS product, comprising:
a CEMS parametric quoting tool in communication with a network, said CEMS parametric quoting tool configured to provide an application that presents a list of CEMS products divided into modules, wherein said application receives customer input in functional requirements and specification via a computer that has access to said CEMS parametric quoting tool to translate said customer inputs into selections of proper CEMS components interactively, further wherein said CEMS parametric quoting tool calculates a customized quote and generates a bill of materials responsive to said customer input and presents said customized quote to a customer and said bill of materials to a manufacturer;
a CEMS knowledge base in communication with said CEMS parametric quoting tool, said CEMS knowledge base configured to provide optimization input to said CEMS parametric quoting tool; and
at least one database in communication with said CEMS parametric quoting tool and said CEMS knowledge base.

19. The system of claim 18, wherein said at least one database comprises a CEMS database that stores information relating to parts and labor costs and inventory, further wherein said CEMS database is in communication with said CEMS parametric quoting tool to allow said CEMS parametric quoting tool to calculate said customized quote.

20. A system for processing a request for an assembled CEMS product, comprising:
a CEMS design expert system in communication with a network, said CEMS design expert system comprising a CAD API program that is configured to receive a customer input and apply customer requirements within said customer input to produce design drawings and a bill of materials for procurement and manufacturing;
a CEMS knowledge base in communication with said CEMS design expert system, said CEMS knowledge base configured to provide optimization input to said CEMS design expert system; and
at least one database in communication with said CEMS design expert system, said CEMS knowledge base, and said CAD API program.

21. The system of claim 20, wherein said at least one database comprises a parameterized design drawing database for storing parameterized design drawings, further wherein said parameterized design drawing database is in communication with said CAD API program.

22. The system of claim 21, wherein said at least one database further comprises a PLC signal database;
said PLC signal database comprising indexed PLC signals in said parameterized design drawings;
said CAD API program further configured to identify said modules in said customer input and determine types of PLC signals of said modules and match said PLC signals of said modules with said indexed PLC signals;
if said CAD API program determines that said PLC signals of said modules and said indexed PLC signals match, said CAD API program automatically extracting one or more of said parameterized design drawings to produce said design drawings.

23. The system of claim 21, wherein said at least one database further comprises a plumbing interface database;
said plumbing interface database comprising indexed plumbing interfaces in said parameterized design drawings;
said CAD API program further configured to identify said modules in said customer input and determine types of plumbing interfaces of said modules and match said plumbing interfaces of said modules with said indexed plumbing interfaces;
if said CAD API program determines that said plumbing interfaces of said modules and said indexed plumbing interfaces match, said CAD API program automatically extracting one or more of said parameterized design drawings to produce said design drawings.

24. The system of claim 20, wherein said at least one database comprises a 2D model database for storing signal and plumbing drawings, and a 3D model database for storing layout drawings, further wherein each of said 2D model database and said 3D model database is in communication with said CAD API program, thereby enabling said CAD API program to include wiring and plumbing representations for major electrical and mechanical equipment in said design drawings.
